(19) United States
(12) Patent Application Publication
(10) Pub. No.: US 2005/0175253 A1
(43) Pub. Date: Aug. 11, 2005

(54) Method for producing cloud free and cloud-shadow free images

(75) Inventors: Min Li, Singapore (SG); Soo Chin Liew, Singapore (SG); Leong Keong Kwoh, Singapore (SG)

Correspondence Address: BURNS DOANE SWECKER & MATHIS L L P, POST OFFICE BOX 1404, ALEXANDRIA, VA, 22313-1404, US

(73) Assignee: National University of Singapore, Singapore (SG)

(21) Appl. No.: 10/502,089

(22) PCT Filed: Jan. 22, 2002
(86) PCT No.: PCT/SG02/00009

(51) Int. Cl. G06K 9/40

(52) U.S. Cl. 382/260

(57) ABSTRACT

A method for generating a cloud free and cloud-shadow free image from a plurality of images of a region, the method including the steps of ranking pixels in order of cloudiness and shadowness, generating cloud and shadow masks by classifying a group of pixels as cloud, shadow, or noncloud-nonshadow, and creating a mosaic from the plurality of images to form the cloud free and cloud-shadow free image.

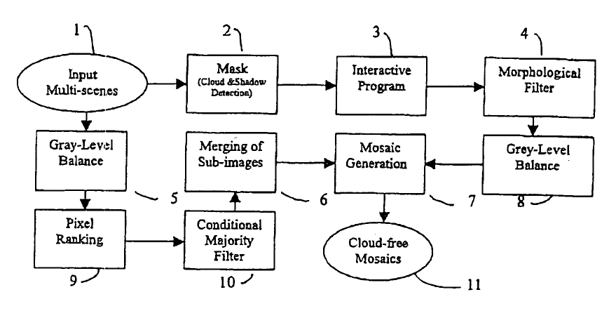

### FIELD OF THE INVENTION

This invention relates to a method for producing cloud free, and cloud-shadow free, images and refers particularly, though not exclusively, to such a method for producing such images from remote sensing using optical sensors.

### BACKGROUND TO THE INVENTION

It is well known that optical remote sensing images often encounter the problem of cloud cover, either partial or complete, especially over humid, tropical regions. There is also the problem of cloud shadow. In the past there have been many attempts to eliminate the problem of clouds appearing in images of a region, the images being taken using optical remote sensing.

The conventional method for generating a cloud free mosaic is by removing the clouds. In undertaking this process, an image containing the least cloud cover is taken as the base image. The cloudy areas in the image are masked out, and then filled in by cloud-free areas from other images acquired at different times This is no more than a manual “cut-and-paste” method.

There have been attempts to automate the procedure. The most common way is to employ a simple intensity threshold process to discriminate the bright cloudy areas and dark cloud shadows from non-cloud areas. This method cannot handle thin clouds and cloud shadows, and often confuse bright land surfaces as clouds. There have been very few proposals for eliminating cloud shadows.

### CONSIDERATION OF PRIOR ART

One proposal for automating the process is disclosed in U.S. Pat. No. 6,233,369. This discloses a system that incorporates a mask for the purpose of performing morphological image processing on one or more adjacent pixels in which a mask is incorporated into a binary image by processing image data which are encoded using 2 bits rather than the usual 1 bit. The specification is directed at the edges of the image where each pixel may not have a complete compliment of neighbours. In this way the second bit is a mask enable bit that directs the processing engine to pass the original data through to the output image regardless of the processing result for that pixel. This allows the masked pixel data is permitted to participate in the computation of all its neighbouring pixel's results.

In U.S. Pat. No. 5,612,901 there is disclosed an apparatus and method for cloud masking in an image of a body of water. It extracts cloud edge information through local segmentation of the image and discriminates between cloud free and cloud contaminated pixels on the basis that clouds are brighter and colder than the surrounding ocean. The cloud-contaminated pixels are then removed.

The disclosure of the specification of U.S. Pat. No. 5,923,383 is directed at an image enhancement method using histogram equalisation so that the brightness of an image is not significantly changed, and the noise is not amplified. This is achieved by expressing the input image in a predetermined gray levels by calculating the distribution of the gray levels of the input image while constraining the number of occurrences of each gray level to be within a predetermined value, and then performing histogram equalisation on the input image based on the calculated distribution of gray levels obtained previously.

On a similar basis, the disclosure of EP 0366099 is directed at a method of image enhancement through the modification of the image histogram by using two matrixes

In EP 0504876A2 there is disclosed a method and apparatus for enhancing an image by further processing in an independent manner the non-brightness information in the image.

Japanese 10-063836 relates to a method for the highlighting of the image using a morphological operation.

In the paper titled “Improved “Cloud-Free Multi-Scene Mosaics of Spot Images” by the present inventors and Lim, Hok (Proceedings of the 19^{th} Asian Conference on Remote Sensing, 1999) there is disclosed an algorithm for automatic generation of “cloud-free” scenes from multiple, multi-spectral images within a specified time interval over a given region. By creating a mosaic using the cloud-free areas in the set of multi-spectral images, a reasonably cloud-free composite image can be made. The algorithm disclosed in the paper does not address the problem of creating a cloud-free mosaic from multiple panchromatic images.

The inputs to the system are multispectral images of the same region acquired within a specified time interval, pre-processed to level 2A or 2B. The images are also co-registered before being fed into the system. The sensor captures data in three spectral bands: the green band, red band, and near-infrared band. The radiometric balancing procedure only makes a correction for differences in sensor gains, solar incidence angles and solar flux between the acquired scenes and no attempt is made to correct for atmospheric effects.

After radiometric balancing, the brightness of pixels at the same location from two different scenes will be a little different due to the atmospheric effects, especially in low-albedo vegetated areas. The pre-processing procedure tries to make a balance between the scenes for the differences caused mainly by atmospheric effects. After radiometric balancing, one image from the set of images is chosen as the reference image. For each band, the pixel values of all other images in the same set are adjusted.

The pixel ranking procedure uses the pixel intensity and suitably chosen band ratios to rank the pixels in order of “cloudiness” and “shadowness” according to predefined ranking criteria.

A shadow intensity threshold and a cloud intensity threshold are determined from the intensity histogram. The pixel ranking procedure uses these shadow and cloud thresholds to rank the pixels in order of “cloudiness” and “shadowness”. Each of the non-cloud and non-shadow pixels in the images is classified into one of four broad classes based on the band ratios: vegetation, building, water and others.

Pixels with lower rank values are more superior and are more likely to be selected. Pixels with intensities falling between the shadow and cloud thresholds are the most superior, and are regarded as the “good pixels”. Where no good pixels are available, the “shadow pixels” are preferred over the “cloud pixels”. Where all pixels at a given location are “shadow pixels”, the brightest shadow pixels will be chosen. In locations where all pixels have been classified as “cloud pixels”, the darkest cloud pixels will be selected.

The rank-1 and rank-2 index maps are used to merge the multi-scenes from the same set of images. If the pixel at a given location has been classified as “vegetation pixel”, the pixels from the rank-1 image and the rank-2 image at that location are averaged together in order to avoid sudden spatial discontinuities in the final mosaic image. Otherwise, the pixels from the rank-1 image are used.

As many pixels as possible in the neighbourhood of a given location come from the same scene. The image that is deemed to have the lowest cloud coverage by visual inspection is chosen to be the base image. Cloud and shadow thresholds are then applied to this base image to delineate the cloud shadows and the cloud covered areas. In the next step of mosaic generation, only the delineated cloud and shadow areas will be replaced with pixels from the merged image generated from the previous step.

The final mosaic is composed from the merged images and the base image. These images are geo-referenced to a base map using control points. The mosaic generation transforms the coordinates of the pixels in the merged images and the base image into map coordinates and put the pixels onto the final image map.

Cloud masking methods based on intensity thresholds cannot handle thin clouds and cloud shadows. They often confuse bright land surfaces as clouds, and dark land surfaces as shadows. In multi-spectral images with two or more spectral bands, the spectral, or colour, information can be used to discriminate different land cover types from clouds. However, in panchromatic or grey scale images, the colour information is absent, and it is even more difficult to discriminate bright land surfaces from clouds, and dark land surfaces from cloud shadows.

It is therefore the principal object of the present invention to address their problems.

A further object is to provide a method for producing cloud free, and cloud-shadow free, images from cloudy panchromatic or grey scale images.

A final object of the present invention is to provide cloud free, and cloud-shadow free, images from cloudy multi-spectral images.

### SUMMARY OF THE INVENTION

The present invention employs pixel ranking. In addition to generating cloud and shadow masks by classifying a group of pixels as cloud, shadow, or noncloud-nonshadow. Each pixel in each of the images may be ranked according to predefined ranking criteria, and the highest ranked pixels are preferably used to compose the mosaic.

By using size and shape information of the bright pixel clusters it is possible to discriminate bright land surface and buildings from clouds. It is also possible to predict the approximate locations of cloud shadows based on the knowledge of solar illumination direction, sensor viewing direction and typical cloud heights.

The present invention also provides for the use of intensity gradients to enable automatic searching for the locations of cloud shadows near the edges of clouds.

The present invention also provides for applying a morphological filter to the cloud masks detected by use of an intensity threshold process in order to include thin clouds around the edges of thick clouds.

The present invention also provides for using a conditional majority filter in addition to the ranking criteria to include as large a patch of neighbouring “good pixels” as possible in the generation of the mosaic. The merging of rank-1 and rank-2 pixels under certain conditions may produce a more pleasing visual effect.

If multiple images acquired at different time over a given region are available, it is practicable to generate a reasonably cloud free composite scene by creating a mosaic of the cloud free areas in the set of images, assuming that the land covers do not change within the time interval. This is particularly relevant for composing “cloud-free” multi-scene mosaics of panchromatic and/or multi-spectral satellite images.

The highest raking pixels may be considered as good pixels and the lowest ranking pixels are considered as bad pixels. The good pixels are preferably further classified into vegetation pixels and building pixels. The building pixels may include land clearings. The classification may depend on whether the pixel intensity is below or above a threshold for vegetation pixels. Darker good pixels may be preferred over brighter good pixels.

The present invention also provides a cloud free and cloud-shadow free image produced by the above method.

In a final form, the present invention provides a computer usable medium having a computer program code which is configured to cause a processor to execute one or more functions to enable the method described above to be performed on at least one computer.

### DESCRIPTION OF THE DRAWING

In order that the invention may be fully understood and readily be put into practical effect, there shall now be described by way of non-limitative example only a preferred embodiment of the present invention, the description being with reference to the accompanying illustrative drawing which is a schematic flow chart of the preferred method of the present invention.

### DESCRIPTION OF PREFERRED EMBODIMENT

The inputs 1 to the system are a plural number of panchromatic and/or multi-spectral images of the same region acquired within a specified time interval, and that are co-registered.

The images are subjected to two different processing streams. In the first stream, along the top of the drawing, at 2 an intensity threshold method is initially applied to generate a cloud mask, and a cloud shadow mask, for each image. Confusion may arise when bright pixels of open land surfaces or buildings are mistaken as cloud pixels. Such confusion may be resolved by making use of size and shape information of the bright pixel clusters detected during the by threshold step. Clouds that need to be masked are much larger than individual buildings. Man-made features such as buildings and land clearings normally have simple geometrical shapes.

At 3, the size of the bright patches is calculated, and the lines and simple shapes of such things as buildings are detected. The intensity threshold method does not work adequately in generating cloud shadow masks. By using geometric modeling, as well as intensity gradients to automatically search for cloud shadows near cloud edges, the preferred method of the present invention compensates for the patch identified improperly in the automatic mask method. Furthermore, solar illumination direction, sensor viewing direction, and typical cloud heights information may be used to predict the likely location of cloud shadows. This is of particular relevance once the locations of the clouds is determined.

As there may be an intensity gradient at cloud edges, a fixed threshold method is used at step 4 to label any thin clouds at cloud edges, as non-cloud pixels. A morphological filter is used to dilate the cloud mask patch. The gray level is then balanced at 8 to compensate for differences caused mainly by atmospheric effects.

After constructing the cloud mask and cloud shadow mask for each component image, in the second stream, at 5 the gray levels are balanced; again to compensate for differences caused mainly by atmospheric effects.

The pixel ranking procedure at 9 uses the shadow, cloud thresholds, and ranking criteria described below, to rank the pixels in order of “cloudiness” and “shadowness”. The pixel ranking procedure uses the pixel intensity to rank the pixels in order of “cloudiness” and “shadowness” according to predefined ranking criteria

In this procedure, a shadow intensity threshold Tₛ, a vegetation intensity threshold Tᵥ and a cloud intensity threshold T_{c} are determined from the intensity histogram. The pixel ranking procedure uses these shadow, vegetation and cloud thresholds to rank the pixels in order of “cloudiness” and “shadowness”. Each of the non-cloud and non-shadow pixels in the images is classified into one of two broad classes based on the intensity: vegetation and building.

For each image n from the set of N acquired images, each pixel at a location (i, j) is assigned a rank rₙ(i, j) based on the pixel intensity Yₙ(i, j) according to the following rules:
For Tₛ≦(Yₘ, Yₙ)≦Tᵥ, if Yₘ<Yₙ (class=“vegetation”), then rₘ<r_{n;} (i)
For Tᵥ≦(Yₘ, Yₙ)≦T_{c}, if Yₘ<Yₙ (class=“building”), then rₘ<rₙ; (ii)
If Yₘ<Tₛ and Yₙ>T_{c}, then rₘ<rₙ; (iii)
For Yₘ, Yₙ<Tₛ, if Yₘ>Yₙ, then rₘ<rₙ; (iv)
For Yₘ, Yₙ>T_{c}, if Yₘ<Yₙ, then rₘ<rₙ; (v)

In this scheme, pixels with lower rank values of rₙ are more superior and are more likely to be selected. Pixels with intensities falling between the shadow and cloud thresholds are the most superior, and are regarded as the “good pixels”. The “good pixels” are further classified into “vegetation pixels” or “building pixels” (that also include land clearings) depending on whether the pixel intensity is below or above the vegetation threshold. The darker “good pixels” are preferred over the brighter “good pixels” as the brighter “good pixels” may be contaminated by thin clouds. Where no good pixels are available, the “shadow pixels” are preferred over the “cloud pixels”. Where all pixels at a given location are “shadow pixels”, the brightest shadow pixels will be chosen. In locations where all pixels have been classified as “cloud pixels”, the darkest cloud pixels will be selected.

After ranking the pixels, the rank-r index map nᵣ(i, j) representing the index n of the image with rank r at the pixel location (i,j) can be generated at 10. It is preferred that only the rank-1 and rank-2 index maps are generated and kept for use in generating the cloud-free mosaics.

In order to obtain improved visual effects, it is desirable to have as many pixels as possible in the neighborhood of a given location to come from the same image. A conditional majority filter procedure is applied to provide this.

In the merging of sub-images at 6, the conditional majority filtered ranking index is used to merge the input multi-scenes that have been processed by the gray-level balance. Using the images with cloud, cloud shadow masks and the merged image generated from the merging of sub-images procedure, the final cloud-free mosaic is composed at 7. The images resulting from the mosaic process are co-registered with the map. The mosaic generation procedure will put the image from the mosaic process into the map at 11.

When merging sub-images, the rank-1 and rank-2 index maps are used to merge the multiple scenes from the same set of images. If the pixel at a given location has been classified as “vegetation pixel”, the pixels from the rank-1 image and the rank-2 image at that location are averaged together in order to avoid spatial discontinuities in the final mosaic image. Otherwise, the pixels from the rank-1 image are used.

The present invention also provides a computer readable medium such as a CDROM, disk, tape or the like, having a computer program thereon, the computer program being configured to cause a processor in a computer to execute one or more functions to enable to computer to perform the method as described above.

The present invention also provides a computer usable medium having a computer program code which is configured to cause a processor to execute one or more functions to enable the method described above to be performed on at least one computer.

Whilst there has been described in the foregoing description a preferred embodiment of the present invention, it will be understood by those skilled in the technology that many variations or modifications in the method of the present invention may be made without departing from the present invention.

1. A method for generating a cloud free and cloud-shadow free image from a plurality of images of a region, the method including the steps of:
(a) ranking pixels in order of cloudiness and shallowness;
(b) using a conditional majority filter on the plurality of images of the region to include as large a patch of neighbouring good pixels from each of the plurality of images as possible;
(c) generating cloud and shadow masks by classifying a group of pixels as cloud, shadow, or noncloud-nonshadow; and
(d) creating a mosaic from the plurality of images to form the cloud free and cloud-shadow free image.

2. A method as claimed in claim 1, wherein each pixel in each of the images is ranked according to predefined ranking criteria, and the highest ranked pixels are used to compose the mosaic.

3. A method as claimed in claim 1, wherein size and shape information of bright pixel clusters are used to discriminate any bright land surfaces and buildings from clouds.

4. A method as claimed in claim 1, wherein solar illumination direction, sensor viewing direction and typical cloud heights information is used to predict likely locations of cloud shadows.

5. A method as claimed in claim 1, where intensity gradients are used to search for locations of cloud shadows near cloud edges.

6. A method as claimed in claim 5, further including the step of applying a morphological filter to the cloud masks detected by the intensity gradients to locate and include thin clouds around the edges of thick clouds.

7. A method as claimed in claim 1, wherein the plurality of images is panchromatic satellite images.

8. A method as claimed in claim 1, wherein the plurality of images is multi-spectral images.

9. A method as claimed in claim 1, wherein the highest raking pixels are considered as good pixels and the lowest ranking pixels are considered as bad pixels.

10. A method as claimed in claim 9, wherein the good pixels are further classified into vegetation pixels and building pixels.

11. A method as claimed in claim 10, wherein the building pixels include land clearings.

12. A method as claimed in claim 10, wherein the classification depends on whether the pixel intensity is below or above a threshold for vegetation pixels.

13. A method as claimed in claim 9, wherein darker good pixels are preferred over brighter good pixels.

14. A cloud free and cloud-shadow free image produced by the method of any one of claim 1.

15. A computer usable medium having a computer program code which is configured to cause a processor to execute one or more steps to enable a computer to perform the method of claim 1.
